(19) United States
(12) Patent Application Publication
(10) Pub. No.: US 2008/0111681 A1
(43) Pub. Date: May 15, 2008

(54) Apparatus, system and method for data transfer by thermal variations

(75) Inventors: Thomas Rathbone, Bristol (GB); Fraser John Dickin, Bristol (GB); Weng Wah Loh, Bristol (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: HEWLETT-PACKARD DEVELOPMENT COMPANY, L.P., Houston, TX (US)

(21) Appl. No.: 11/490,019

(22) Filed: Jul. 21, 2006

(30) Foreign Application Priority Data
Aug. 27, 2005 (GB) 0517554.2

(51) Int. Cl. G08B 21/00

(52) U.S. Cl. 340/540

(57) ABSTRACT

The invention provides a receiver 120 having a sensor 114 configured to output a signal representative of temperature variation detected at the sensor 114. A decoder 118 connected to the sensor 114 decodes the signal detected by the sensor 114 and outputs a stream of data which has been encoded in the temperature variation. The receiver 120 may be for use with a microprocessor 202, for example the microprocessor 202 of a memory tag 200 which includes a voltage regulator 210 in power circuitry 206. A system 100 and method 300 for transferring data are also provided.

### CLAIM TO PRIORITY

This application claims priority to co-pending United Kingdom utility application entitled, “Apparatus, System and Method for Data Transfer by Thermal Variations” having serial no. GB 0517554.2, filed Aug. 27, 2005, which is entirely incorporated herein by reference.

### FIELD OF THE INVENTION

This invention relates generally to data transfer. In particular, the present invention relates to an apparatus, system and method of data transfer using thermal fluctuations. In particular, the invention relates to a technique of data transfer using a thermal characteristic which can be detected at a receiver. The receiver may be implemented in a microprocessor of a memory device.

### BACKGROUND

Wireless data transfer has become commonplace in recent years as the number of electronic devices which communicate with each other has increased. There is now a large variety of electronic devices which communicate with each other over wireless communication links.

Wireless communication links can be direct “line-of-sight” communication links in which there is a direct path between the transmitter of one device and the receiver of the other device. In such communication links, the receiver must be located within the path of the signal used to transmit data between the devices. Of course, the path of the signal may not necessarily be a straight line between the transmitter and receiver—the signal may, for example, be reflected off one or more surfaces. However, in all direct “line-of-sight” communication links, there is no obstruction in the path of the signal between the transmitter and receiver which alters in any significant way the characteristics of the transmitted signal. An example of a “line-of-sight” communication link is an infra-red communication link in which an electromagnetic wave is generated at the transmitter in the infra-red spectrum of the electromagnetic spectrum (“an infra-red signal”). Infra-red signals generally have a frequency in the range of 3×10³ to 4.3×10⁵ GHz. The infra-red signal can be modulated in a number of different ways so that it can carry data from the transmitter to the receiver. In an infra-red communication link, the transmitter and receiver must generally be arranged in such a way that there is a direct path for the infra-red signal to travel between them. Infra-red communication links are well documented and many examples of electronic devices employing such links exist, for example personal computers, audio/visual equipment and mobile telephones.

Alternatively, short range communication links may be direct communication links in which there does not need to be a direct “line-of-sight” signal path between the transmitter and receiver (“a non-line-of-sight communication link”). The transmitter does not need to be directed in any particular direction for a signal to be received by the receiver.

An example of a non-line-of-sight communication link is a short range radio frequency (RF) communication link in which an electromagnetic wave is generated at the transmitter in the radio frequency range (“an RF signal”). RF signals generally have a frequency in the electromagnetic spectrum of less than 3 GHz. RF signals can be emitted in a non-directional way so that a transmitter does not necessarily need to be directed towards a receiver. For these reasons, RF communication links are often used for short range wireless communication where there might not necessarily be a direct unobstructed path from the transmitter to the receiver. Short range RF communication links generally operate in a frequency range of 2 to 3 GHz. At this frequency range, there does not need to be a direct path between a transmitter and a receiver. Since this frequency range is at the upper end of the RF frequency range, complex and power intensive transceivers are often required to communicate even over short distances. On example of a well-documented technology for implementing standardised short range RF communication links is Bluetooth® which operates at 2.4 GHz.

Short range RF communication links operating at the upper end of the RF spectrum are often restricted by legislation to specific data transfer rates, transmission powers and carrier frequencies to reduce electronic interference. In the United States, the Federal Communications Commission (FCC) regulates wireless telecommunication. At the current time, for short range RF communication links operating at 2.4 GHz, transmission power is generally restricted by legislation to 100 mW and the maximum data transfer rate is limited 10 Mbps. This regulation exists to prevent excessive electromagnetic interference between electronic devices.

Radio frequency identification tags (RFID) use short range RF communication. A memory tag is an example of an RFID tag.

RFID tags come in many forms but all comprise an integrated circuit on which data can be stored and a coil which enables it to be interrogated by a transceiver that also powers it by means of an RF wireless communications link. Some RFID tags include read-only memory (ROM) and are written to at the time of manufacture, whilst others have read and write capability.

RFID tags incorporate a number of elements. These include an antenna which couples inductively with an antenna in a tag transceiver, an RF decoder for decoding radio frequency signals received via the antenna, a processor for processing the received signals and an area of non-volatile memory. A voltage regulator in the processor operates to provide a constant voltage for powering the RFID tag.

Passive RFID tags do not comprise an on board power supply. As already noted, they are powered by electromagnetic radiation transmitted from a tag transceiver. It is desirable to keep power consumption within the memory tag to a minimum.

Often, there will be no direct “line-of-sight” communication path between the RFID tag and the tag transceiver. For example, the RFID tag could be contained inside an article or piece of clothing.

Power and data is normally transferred to a memory tag using a high frequency RF signal carrier (e.g. 2.4 GHz) which is amplitude modulated.

The power needed for the electronics in the RFID tag is derived from the electromagnetic radiation generated by a transmitter. Data is transferred to the RFID by modulating the electromagnetic radiation in empathy with the data stream. There are many techniques of modulating data onto a radio frequency channel, however, a simple and common technique used in RFID tags and similar devices employing RF communication is amplitude modulation. In this technique, the amplitude of the transmission signal is varied according to the data stream. For example, when transmitting a logical ‘1’, high power is applied, when transmitting a logic ‘0’, low power is applied.

FIG. 1a shows how power and data can be sent to an RFID tag using amplitude modulation.

A transmitter 10 includes a radio frequency generator 11 and a data source 12. Digital data from the data source 12 is amplitude modulated in a modulator 13 onto a RF carrier output by the radio frequency generator 11. The resulting RF signal 15 is output from the transmitter 10 via a transmitter antenna 14.

A receiver 16 receives the RF signal 15 via a receiver antenna 17. The transmitted data is extracted from the signal in demodulator 18 and passed to processing circuitry 19 in the RFID tag. In addition, the RF signal is passed through a diode 20 and across a capacitor 21 to generate a DC voltage. The DC voltage is passed through a voltage regulator 22 to generate a constant output voltage to act as a power supply for the processing circuitry 19.

In order to achieve stabilsed power shown in FIG. 1a using analogue modulation, the capacitor 20 needs to be large. In addition, the voltage regulator 22 is complex and needs to operate at high speeds. The capacitor 20 requires a large silicon area to implement if an RFID tag is to be implemented on silicon. An increased silicon area increases the cost of the each RFID tag.

### SUMMARY

In a first aspect of the invention, there is provided a method of transferring data, comprising: encoding data in a signal; generating a temperature variation at a surface of a memory device; generating a signal indicative of the detected thermal variation at a sensor in the memory device; decoding the data from the signal indicative of the detected thermal variation; and outputting the data.

In a second aspect of the invention, there is provided a memory device comprising: a temperature sensor configured to detect temperature variation at a surface of the memory device and output a signal corresponding to the temperature variation; a decoder connected to the sensor configured to decode data encoded in the temperature variation and output the decoded data; a microprocessor for receiving the decoded data from the decoder; and an array of non-volatile memory for storing data output by the microprocessor.

In a third aspect of the invention, there is provided a data transfer system comprising the memory device of the present invention and further comprising a heat source adapted to generate the temperature variation at the surface of the memory device.

### BRIEF DESCRIPTION OF THE DRAWINGS

Specific embodiments of the present invention are now described, by way of example only, with reference to the accompanying drawings in which:

FIG. 1a is a schematic of a prior art data transfer system employing RF data transfer;

FIG. 1b is a schematic of a data transfer system according to the invention;

FIG. 2a is a schematic of a receiver according to the invention;

FIG. 2b is a schematic of a detector used in the receiver of FIG. 2a;

FIG. 3 is a flow diagram depicting the method of data transfer according to the invention; and

FIG. 4 is a representation of a data signal transmitted and received according to the invention.

### DETAILED DESCRIPTION OF THE PREFERRED EMBODIMENTS

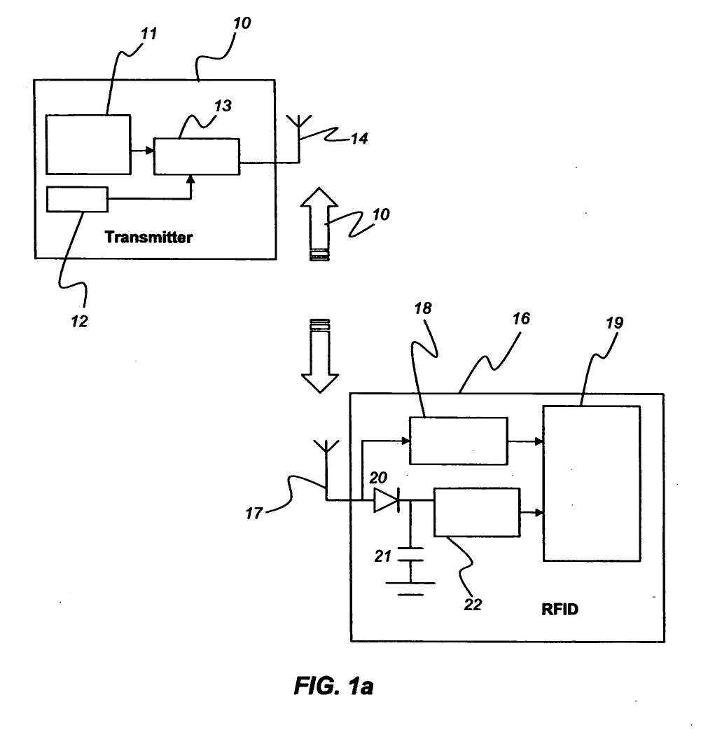

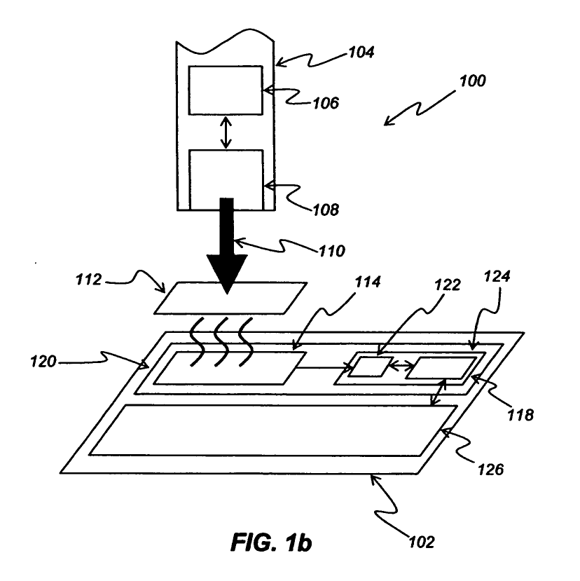

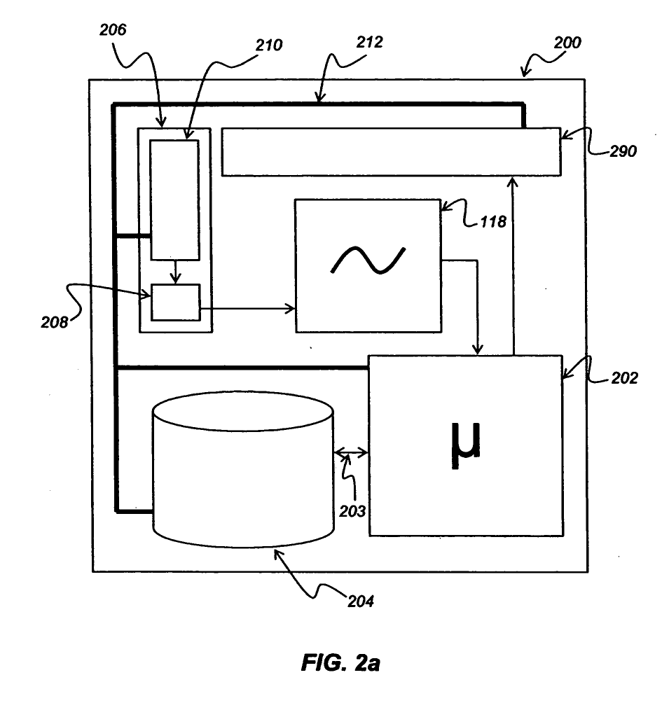

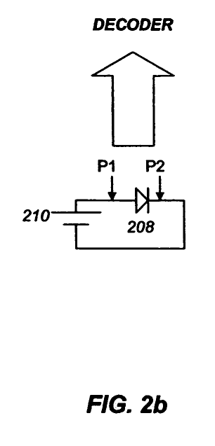

The present invention, which will now be described with reference to FIG. 1b, is a system 100 for transferring data to a receiving device 102. The receiving device 102 is shown in FIG. 2a in the form of a memory tag 200. However, as will be readily appreciated by the skilled reader, the invention is not limited to use with memory tags and may readily be implemented in other applications, especially those where short range indirect wireless data transfer is required.

As stated above, the system 100 of the present invention comprises a receiving device 102 and a transmitter 104. The transmitter 104 comprises a data encoder 106 which receives input data to be written to the receiving device 102 from a data source (not shown). The data encoder 106 is connected to a heat-generating source. Any heat-generating source which provides an electronically variable source of heat can be used. A laser 108 suitable for spot heating (for example as used in CDRW writers) is shown in FIG. 1b for illustration. The laser 108 generates a coherent directed beam 110 of electromagnetic radiation.

Data is modulated by the data encoder 106 with a modulation technique such as amplitude modulation (AM), specifically binary or multilevel amplitude shift keying (ASK), or, alternatively, differential modulation.

With amplitude modulation (AM), the intensity of the laser beam 110 varies according to binary data fed into the data encoder 106. In amplitude shift keying (ASK), bit sequences in a data stream are assigned a level in the modulated signal. For example, a four-level ASK encoding scheme can represent two bits in the data stream.

In differential modulation, rather than transmitting an absolute amplitude for each bit (or bit sequence), only changes in the data stream are transmitted.

In the embodiment shown in FIG. 1b, the data encoder 106 is connected to a laser 108 which generates a coherent directed beam 110 of electromagnetic radiation. The laser 108 is suitable for spot heating a point to 800 degrees Celsius and generates the electromagnetic radiation in the infra-red frequency range (i.e. 3×10³ to 4.3×10⁵ GHz). The laser 108 modulates the power of the beam 110 according to one of four discrete power levels on the basis of a discrete power level signal received from the encoder 106.

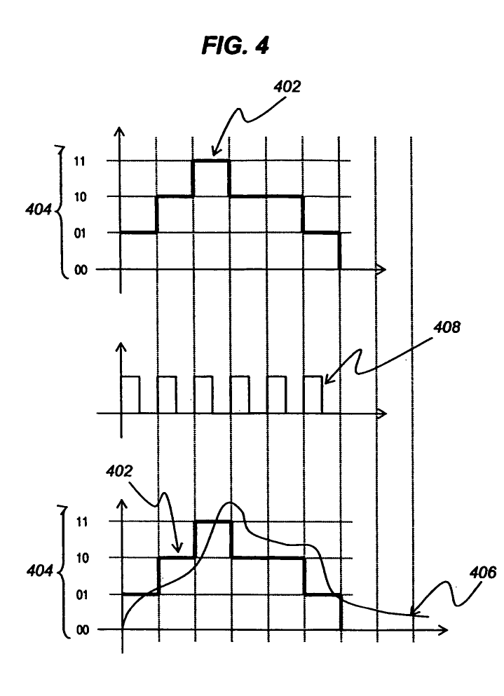

The encoder 106 generates a power level signal using four-level ASK of each sequential 2 bit binary data sequence contained in the input data. Amplitude shift keying of the input data is explained in more detail below with reference to FIG. 4.

The transmitter 104 is orientated in such a way that the beam 110 is incident on a surface 112 which is in thermal contact with a sensor 114. The surface 112 may, for example, be the enclosure containing the receiving device 102. Alternatively, the surface 112 may be a section of clothing covering the receiving device 102. Of course, the surface 112 may comprise multiple layers of material in thermal contact with each other, for example, a layer of clothing surrounding the protective casing of the receiving device 102. As will be appreciated, no direct “line-of-sight” communication between the laser 108 and the sensor 114 is required.

The sensor 114 is a heat sensitive detector which generates an output voltage signal, the level of which is dependent on the temperature detected by the sensor 114. The sensor 114 is heated via thermal conduction of heat from the surface 112 which has been heated by the beam 110 being incident on the surface 112, thereby causing thermal variations which can be detected by the sensor 114.

As will be appreciated, the laser 108 may be a laser which outputs electromagnetic energy in the infra red spectrum. However, the operation of the sensor 114 is different to the operation of an infra red detector. The sensor 114 is a heat detector and outputs a voltage signal which is indicative of variation in detected heat. In contrast, an infra red detector outputs a signal which is indicative of variation in intensity of incident electromagnetic radiation. One advantage of a heat detector is that no direct “line-of-sight” communication between the laser 108 and an infra-red detector is required.

The sensor 114 is connected to a decoder 118 which receives the output voltage signal (“temperature signal”) generated by the sensor 114. In the embodiment depicted in FIG. 1, both the sensor 114 and the decoder 118 are components of a receiver 120. The decoder 118 comprises a filter circuit 122, preferably a digital filter implemented in a digital signal processing (DSP) circuit, and a demodulator 124. The filter circuit 122 is configured with a built-in frequency response function which is correlated with the thermal response of the receiver 120.

The thermal response of receiver 120 is such that its temperature increases and decreases through thermal conduction into and out of the receiver 120 depending on the power of the beam 110 which is incident on the surface 112. Thus, the digital filter 122 applies the built-in frequency response function to the output voltage signal to remove the interference introduced by the thermal response of the receiver 120 and outputs a filtered ASK signal to the demodulator 124.

The demodulator 124 converts the filtered ASK signal into a serial data stream of binary data which is received by processing logic 126 of the receiving unit 102.

FIG. 2a shows the receiving unit 102 of FIG. 1b in the form of a memory tag 200. The memory tag 200 comprises a microprocessor 202 connected to non-volatile memory 204 via data bus 203, power circuitry 206, an RF transmitter 290 connected to the microprocessor 202, and a decoder 118.

The power circuitry 260 includes a heat sensitive detector 208 which generates an output voltage from thermal energy received at the power circuitry 260. The thermal energy may be transmitted and received through any form of thermal phenomenon, e.g. thermal conduction or electromagnetic radiation which is converted to heat when it is incident on the power circuitry 260. A thermal phenomenon is defined as any energy transfer mechanism which can be detected, either directly or indirectly, by measurement of temperature variation.

The heat sensitive detector 208 is connected to a voltage source 210.

The voltage source 210 provides a fixed-level voltage on power bus 212 which is connected to the various components of the memory tag 200 as shown in FIG. 2a. The voltage source 210 may be provided by a thermocouple selected and configured to receive thermal energy from the transmitter 104. In this way, thermal energy transmitted to the power circuitry 260 can be used to power the memory tag 200. The voltage source may also include a voltage regulator (not shown) and capacitor to provide a constant fixed level output voltage. Since data transfer in the present invention is achieved without modulating RF power, a large capacitor and a complicated voltage regulator is not required.

The data transfer rate that can be achieved between the transmitter 108 and the receiver 102 is a function of the rate at which the detector 208 can be heated up and cooled down. The cooling rate is a function of thermal properties of the material on which the detector 208 is constructed.

Thermal diffusivity through the material can be expressed as k=a/(ρ×c), where c is the specific heat of the material, ρ is the material density, and a is material thermal conductivity. The time, t, required for heat to diffuse a distance of one metre in a material can be expressed as follows:—

t˜l²/k

where l² represents the cross-sectional area of the material in a plane tangential to the direction of heat diffusion.

Since the data transfer rate is dependent on the time, t, the thermal diffusivity should be high to achieve a high data transfer rate. In one embodiment, the thermal diffusivity should be greater than 0.6 cm²/s when the area of the material on which the detector is mounted is 100 sq microns. Such an arrangement results in a time for heat of dissipation of 167 micro-seconds which allows fast data transfer. Preferably, the thermal diffusivity should be greater than or equal to 0.8 cm²/s which is the approximate thermal diffusivity of silicon.

If the detector is constructed in a small area and is mounted on a heat dissipater having a high thermal diffusivity, such as a metal, a high data transfer rate can be achieved.

FIG. 2b shows, in one embodiment of the invention, components of the power circuitry 260. The voltage source 210 is connected in parallel to the detector 208 which is a diode.

When a small forward bias is applied to the diode, the voltage drop across the diode junction (between P1 and P2) changes at a rate of about 2.24 mV/degree Celsius. Hence, the variation in voltage across the diode is representative of temperature variation in thermal energy incident on the diode. The variation in voltage is output as a temperature signal to decoder 118.

The decoder 118 of FIG. 2a operates in the same way as the decoder 118 of the receiving unit 102 shown in FIG. 1b. The temperature signal is filtered to remove the background thermal response of the memory tag 200 and demodulated to generate an output data stream which is input to the microprocessor 202.

The microprocessor 202 of FIG. 2a interprets the output data and initiates a processing step based on the output data. For example, the processing step might comprise reading the memory 204 at an address specified by the output data. Alternatively, the processing step might comprise writing data contained in the output data to an address in the memory 204 which is specified in the output data. The detailed operation of the memory tag and of its microprocessor 202 is not directly relevant to the present invention and has been described in co-pending United Kingdom patent application, publication No GB2395592 and application No GB0426771.2 filed on 7 Dec. 2004 which are hereby incorporated by reference.

The microprocessor 202 is connected to an RF transmitter 290 which is adapted to transmit data received from the microprocessor 202 over an RF link to an RF receiver (not shown). In contrast to transmission of data into the memory tag 200, it is still more effective, due to the size and power constraints of the memory tag 200, to transmit data out of the memory tag 202 across an RF communication link. RF transmitters for use in memory tags are known and a detailed discussion of their operation is not necessary for the purposes of understanding the present invention. The transmitter 104 (described with reference to FIG. 1b) and the RF receiver can be combined into a single unit known as a tag transceiver.

As will be appreciated, the receiver 120 of the receiving device 102 of FIG. 1b equates to a combination of the power circuitry 206 and the decoder 118 in the memory tag 200 of FIG. 2a. The sensor 114 of FIG. 1b is equivalent to the detector 208 and regulator 210 of the power circuitry 206. As stated above, the power circuitry 206 has the additional advantageous feature of providing a power supply for the memory tag 200 from received thermal energy. Hence, the level of power transmitted wirelessly to the memory tag 200 is not restricted in the same way as would be the case for RF transmission of power.

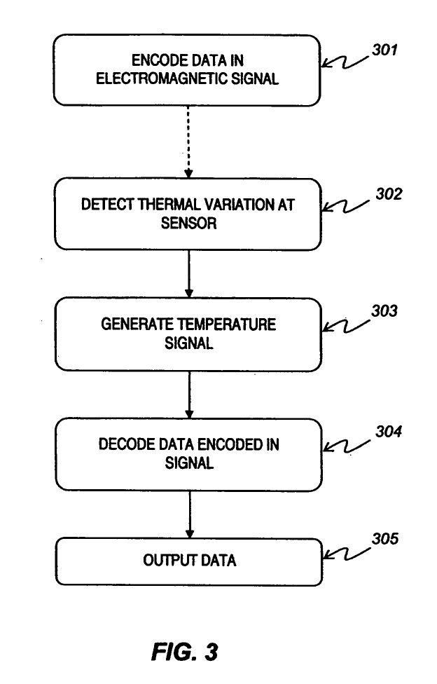

FIG. 3 is a flow diagram illustrating the method of the present invention.

Data which is to be sent to the receiving device 102 is encoded by the transmitter 104 in a beam 110 of electromagnetic radiation using amplitude shift keying (ASK) in which different levels of power of the beam 110 represent specific sequences of binary data present in the data (step 301).

When the electromagnetic signal is incident on the receiving device 102 or a surface 112 which is in thermal contact with the receiving device 102, heat is generated which is detected by the sensor 114 (step 302). The detected temperature corresponds to a level of power which was present in the beam 110. The temperature therefore represents a specific sequence of binary data.

The sensor 114 outputs a voltage (“a temperature signal”), the level of which represents the detected temperature (step 303).

The decoder 118, which is connected to the sensor 304, extracts the data encoded in the temperature signal by filtering and demodulating it (as explained above) (step 304).

The decoder 118 outputs a serial data stream of binary data to the processing logic 126 (step 305).

FIG. 4 shows representations of: (i) an example power level signal 402 which is output by the encoder 106; and (ii) the temperature signal 406 (for the same data represented by the power level signal 402) which is output by the sensor 114. As will be deduced from FIG. 4, the data represented by the power level signal corresponds to the data stream “011011101001”.

Using ASK, the encoder 106 encodes 2 bit binary sequences 404 of data into one of four power levels as shown in FIG. 4. Since the power level signal 402 is input directly into the laser 108, the power of the beam 110 output by the laser 108 represents one of the binary sequences.

The temperature signal 406 which is output by the sensor 114 is an AC waveform which does not have discrete voltage levels (in contrast to the power level signal generated by the encoder 106). The principal reason for this is that the frequency response of the sensor 114 to heating (and any surface 112 through which the heat induced by the beam 110 passes) introduces a delay into the temperature generated by the heating. In addition, the receiving unit 102 loses heat by conduction and radiation. For this reason, the temperature signal 406 is filtered by the filter 122 according to a predetermined transfer function which is determined by experimentation during design of the receiving unit 102. In addition, scaling of the temperature signal 406 is carried out during filtering so that the differences between voltage levels correlate with the different levels of the power level signal 402.

A clock signal 408 is used by the encoder 106 and the demodulator 124 to synchronise the coding and demodulation of the data. Coding of the data occurs on a rising-edge boundary of the clock signal 408, whereas sampling of the filtered data in the demodulator occurs on falling-edge clock boundary. The clock signals of the encoder 106 and demodulator 124 are synchronised with a synchronisation burst transmitted by the transmitter 104 before data transfer commences.

It will of course be understood that the present invention has been described above by way of example only and that modifications of detail can be made within the scope of the invention.

1. A method of transferring data, comprising:
encoding data in a signal;
generating a temperature variation at a surface of a memory device which corresponds to the original;
generating a signal indicative of the detected thermal variation at a sensor in the memory device;
decoding the data from the signal indicative of the detected thermal variation; and
outputting the data.

2. The method of claim 1, wherein the temperature variation is generated by transmitting electromagnetic radiation from a heat source and the step of encoding comprises encoding the data in the electromagnetic radiation.

3. The method of claim 2, wherein the frequency of the electromagnetic radiation is in the range of 3×10³ to 4.3×10⁵ GHz.

4. The method of claim 1, wherein the step of decoding comprises filtering the generated signal to remove a background temperature response of the sensor.

5. The method of claim 1, wherein the step of encoding comprises encoding the data using amplitude shift keying.

6. A memory device comprising:
a temperature sensor configured to detect temperature variation at a surface of the memory device and output a signal corresponding to the temperature variation;
a decoder connected to the sensor configured to decode data encoded in the temperature variation and output the decoded data;
a processor for receiving the decoded data from the decoder; and
an array of non-volatile memory for storing data output by the processor.

7. The memory device of claim 6, wherein the temperature sensor is configured to detect temperature variation through thermal conduction from the surface.

8. The memory device of claim 6, wherein the data is encoded in the temperature variation at a data transfer rate greater than 2 Mbits per second.

9. The memory device of claim 6, wherein the data is encoded in the temperature variation at a data transfer rate greater than 5 Mbits per second.

10. The memory device of claim 6, wherein the data is encoded in the temperature variation at a data transfer rate greater than 10 Mbits per second.

11. The memory device of claim 6, wherein the data is encoded in the temperature variation using amplitude shift keying.

12. The memory device of claim 6, further comprising a voltage regulator which includes the sensor.

13. The memory device of claim 12, wherein the voltage regulator is adapted to generate a constant output voltage from thermal energy received at the sensor, thereby providing a constant voltage power supply for the microprocessor.

14. A data transfer system comprising the memory device of claim 6 and further comprising:
a heat source adapted to generate the temperature variation at the surface of the memory device.

15. The data transfer system of claim 14, wherein the heat source generates the temperature variation by transmitting electromagnetic radiation to the surface.

16. The data transfer system of claim 15, wherein the sensor is configured to detect the temperature variation through conduction of heat from the surface.
